(19) United States
(12) Patent Application Publication
(10) Pub. No.: US 2008/0091836 A1
(43) Pub. Date: Apr. 17, 2008

(54) Network system, service retrieving method and image forming apparatus

(75) Inventor: Eriko Kato, Nerima-ku (JP)

Correspondence Address: SIDLEY AUSTIN LLP, 717 NORTH HARWOOD, SUITE 3400, DALLAS, TX, 75201, US

(73) Assignee: KONICA MINOLTA BUSINESS TECHNOLOGIES, INC.

(21) Appl. No.: 11/901,187

(22) Filed: Sep. 14, 2007

(30) Foreign Application Priority Data
Oct. 16, 2006 (JP) JP2006-281365

(51) Int. Cl. G06F 15/16

(52) U.S. Cl. 709/229

(57) ABSTRACT

There is described a network system, which make it possible not only to easily retrieve a desired service, but also to heighten the security level of the network system. Instead of displaying all of the apparatuses residing on the network in such a manner that these are totally perceptible for the users of them relative to each other, the network system is so constituted that the service utilizing apparatus broadcasts the delivery information including the confirming information, so that each of the service providing apparatuses can determine whether or not the first confirming information included in the delivery information agrees to the second confirming information stored in advance in the storage section, and when the service providing apparatus determines that the first confirming information agrees to the second confirming information, the service providing apparatus transmits specific information for specifying the service providing apparatus itself to the service utilizing apparatus.

This application is based on Japanese Patent Application No. 2006-281365 filed on Oct. 16, 2006 with Japan Patent Office, the entire content of which is hereby incorporated by reference.

### BACKGROUND OF THE INVENTION

The present invention relates to a network system, a service retrieving method to be employed in the network system and an image forming apparatus, which utilizes or provides the service retrieved by employing the service retrieving method.

In the network system in which an apparatus utilizing a service and another apparatus providing the service are coupled to each other through a network, when the user retrieves or searches a desired service, generally, all of the apparatuses coupled to the network are displayed on a screen provided for the user, so that the user can employ such a method that includes the steps of: selecting an apparatus that can provide the desired service while referring to the names of apparatuses, etc., and then, establishing communication with the selected apparatus by employing a predetermined ID or a password.

For instance, Patent Document 1 (Tokkai 2004-280607, Japanese Non-Examined Patent Publication) sets forth such a configuration that, in the system in which the personal computers and the digital multi-function apparatus are coupled to each other through a network, the digital multi-function apparatus retrieves a specific personal computer in which a common folder is established, so as to display the name of the common folder in the concerned personal computer on the screen provided with the touch panel, and then, the user selects the common folder by operating the touch panel, in order to make it possible to store the image data acquired by the digital multi-function apparatus into the common folder.

According to the conventional service retrieving method mentioned in the above, with respect to a network, which includes a small number of apparatuses providing the service, or a local or closed network, since the user already knows what kind of apparatuses coupled to the network, it is possible for the user to discriminate the various kinds of apparatuses, based on the names of the apparatuses, etc. However, with respect to a network, which includes a large number of apparatuses providing the service, or an open network, since it is impossible for the user to grasp what kind of apparatuses are currently existing in the network system, the user cannot discriminate the various kinds of apparatuses from the names of the apparatuses, etc. Accordingly, there has arisen the problem that the desired service could not be easily retrieved.

Further, generally speaking, in order to make it possible to retrieve the desired service on the network, a predetermined application program is employed for displaying all of the apparatuses in the network on the screen of each apparatus, in such a manner that all of the apparatuses can be recognized relatively from each other. However, if the network configuration is disclosed openly as mentioned in the above, the existence of the apparatus currently retrieving the service could be perceived by another user, resulting in undesirable access from the other user, etc. This would arise another problem that it is impossible to guarantee the security of the network system.

### SUMMARY

To overcome the abovementioned drawbacks in conventional network systems, it is one of objects of the present invention to provide a network system, a service retrieving method and an image forming apparatus, which make it possible to easily retrieve a desired service. Further, it is another one of objects of the present invention to provide a network system, a service retrieving method and an image forming apparatus, which make it possible to heighten the security level of the network system.

Accordingly, at least one of the objects of the present invention can be attained by the network systems, the service retrieving methods and the image forming apparatuses described as follows.

(1) According to a network system reflecting an aspect of the present invention, the network system comprises: a service providing apparatus that provides a service; a service utilizing apparatus that utilizes the service provided by the service providing apparatus; and a network through which the service providing apparatus and the service utilizing apparatus bilaterally communicate with each other; wherein the service utilizing apparatus includes: a first communicating section that is connected to the network; and a first control section that creates delivery information including first confirming information, which is necessary for authenticating a usage of the service, and broadcasts the delivery information onto the network through the first communicating section; and wherein the service providing apparatus includes: a second communicating section that is connected to the network; a storage section to store second confirming information in regard to a usage authentication of own service being providable by the service providing apparatus; and a second control section that receives the delivery information through the second communicating section, and determines whether or not the first confirming information included in the delivery information agrees to the second confirming information stored in advance in the storage section; and wherein, when the second control section determines that the first confirming information agrees to the second confirming information, the second control section transmits specific information for specifying the service providing apparatus to the service utilizing apparatus through the second communicating section.

(2) According to another aspect of the present invention, in the network system recited in item 1, the first control section of the service utilizing apparatus makes the delivery information include information for specifying a kind of service to be utilized; and the second control section of the service providing apparatus determines whether or not the kind of service, specified by the information included in the delivery information, is providable by the service providing apparatus, and, when determining that the kind of service is providable, the second control section determines whether or not the first confirming information included in the delivery information agrees to the second confirming information stored in advance in the storage section.

(3) According to still another aspect of the present invention, in the network system recited in item 1, at least one of the service utilizing apparatus and the service providing apparatus is an image forming apparatus; and the service is either a data storage service for storing image data generated by the image forming apparatus, or a secure print service for outputting a print based on the image data, after an authenticating process is completed.

(4) According to yet another aspect of the present invention, in the network system recited in item 1, the confirming information include at least one of a user's ID and a password, both for identifying a user.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows a schematic diagram of a configuration of a network system embodied in the present invention;

FIG. 2(a) and FIG. 2(b) show configurations of an image forming apparatus, indicating an outer appearance and a block diagram of the image forming apparatus embodied in the present invention, respectively;

FIG. 3(a) and FIG. 3(b) show schematic diagrams indicating information transmitting flows in a network system embodied in the present invention, indicating a case of a single segment and another case of including a separate segment, respectively;

FIG. 4 shows a screen configuration example (service selection screen) to be displayed on a display section of an image forming apparatus embodied in the present invention;

FIG. 5 shows a screen configuration example (confirming information inputting screen) to be displayed on a display section of an image forming apparatus embodied in the present invention;

FIG. 6 shows a screen configuration example (card/biological information inputting screen) to be displayed on a display section of an image forming apparatus embodied in the present invention;

FIG. 7(a) and FIG. 7(b) show screen configuration examples (first and second storage selection screens) to be displayed on a display section of an image forming apparatus embodied in the present invention;

FIG. 8 shows a screen configuration example (secure print selection screen) to be displayed on a display section of an image forming apparatus embodied in the present invention;

FIG. 9 shows a screen configuration example (FTP/WWW selection screen) to be displayed on a display section of an image forming apparatus embodied in the present invention;

FIG. 10 shows a flowchart indicating a data storage service retrieving procedure, which utilizes a network system embodied in the present invention and is to be conducted in the service utilizing apparatus side;

FIG. 11 shows a flowchart indicating a secure print service retrieving procedure, which utilizes a network system embodied in the present invention and is to be conducted in the service utilizing apparatus side;

FIG. 12 shows a flowchart indicating a FTP/WWW service retrieving procedure, which utilizes a network system embodied in the present invention and is to be conducted in the service utilizing apparatus side; and

FIG. 13 shows a flowchart indicating a service retrieving procedure, which utilizes a network system embodied in the present invention and is to be conducted in the service providing apparatus side.

### DETAILED DESCRIPTION OF THE PREFERRED EMBODIMENTS

As described in the “BACKGROUND OF THE INVENTION”, since it is impossible to easily retrieve the desired service, when retrieving the apparatus that can provide the desired service in the network system in which a plurality of apparatuses are coupled to each other through the network, there has been a problem that it is impossible to guarantee the security of the network system. Such the problem has been caused by the fact that the user himself employs one of apparatuses residing on the network system to display all of the apparatuses registered in the network system, and then, retrieves a certain apparatus that can provide the desired service, from all of them by referring to the names of the apparatuses, etc. Accordingly, to overcome such the drawback, in the embodiment of the present invention detailed in the following, instead of such the practice that the user himself retrieves a certain apparatus that can provide the desired service, each apparatus registered in the network system is made to determine whether or not the apparatus itself can provide its own service for the user.

Concretely speaking, in the network system in which at least an apparatus utilizing a service (hereinafter, also referred to as a service utilizing apparatus, for simplicity) and at least another apparatus providing the service (hereinafter, also referred to as a service providing apparatus, for simplicity) are coupled to each other through the network, confirming information in regard to a usage approval of the service provided by itself (for instance, an ID and a password, information of the card possessed by the user, biological information of the user, etc.) are stored in advance in at least a service providing apparatus, and delivery information including the confirming information necessary for the usage approval of the service are created in the service utilizing apparatus. Then, the concerned delivery information is broadcasted through the network, so as to determine whether or not the confirming information to be included in the delivery information is stored in advance in the service providing apparatus. If the confirming information is included in the service providing apparatus, the service utilizing apparatus notifies the information, for specifying the concerned service utilizing apparatus itself (for instance, an IP address and/or a port number), of the service providing apparatus.

According to the above, since it becomes unnecessary for the user to retrieve a specific apparatus that can provide the desired service, it becomes possible to make the service retrieving operation easy. Further, since it becomes unnecessary to disclose the configuration of the whole network, it also becomes possible to improve the security of the network system.

In this connection, a service called the BM Link Service has been proposed for making the usage of a copier or a multi functional apparatus, which is provided with a copy function and facsimile function, a printing function, a scanner function, etc., (hereinafter, referring to an image forming apparatus as a general name) easy. Although the standardizing operation is conducted by specifying the directory service protocol in the BM Link Service, even in this network, to retrieve a desired image forming apparatus, it is the user that should initially retrieve the image forming apparatus concerned. Further, even if the image forming apparatus concerned can be listed up by the retrieving operation, there would arise another problem whether or not the retrieved service is available for the user who implemented the retrieving operation. In contrast to the above, by employing the network system embodied in the present invention and detailed in the following, it becomes possible for the user to easily retrieve the service released to the user.

Referring to the drawings, with respect to the network in which an image forming apparatus is utilized so as to serve as either the service utilizing apparatus or the service providing apparatus, a concrete example embodied in the present invention will be detailed in the following.

### Embodiment

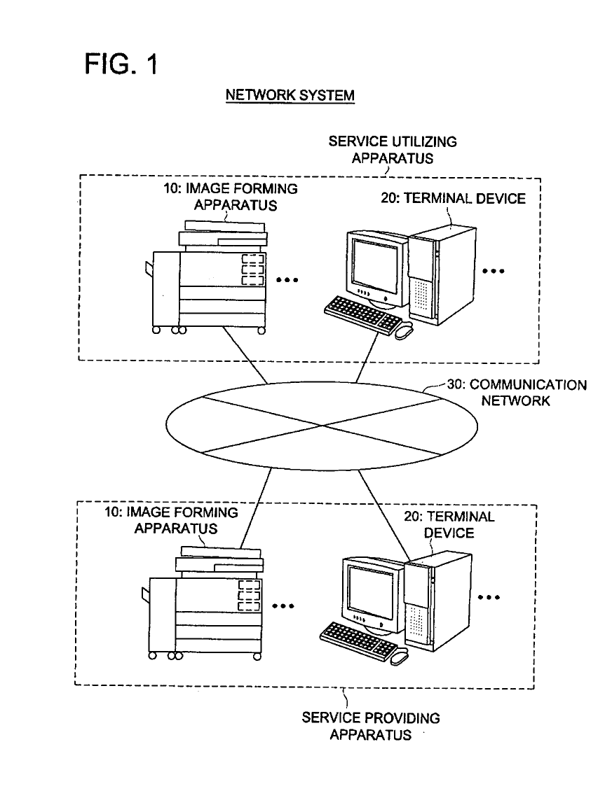

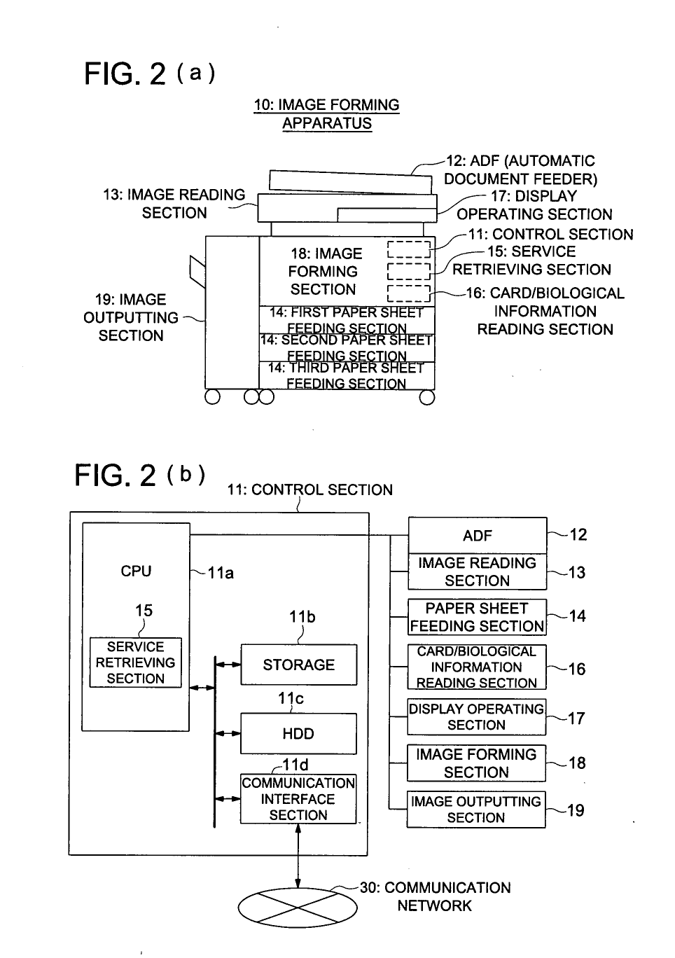

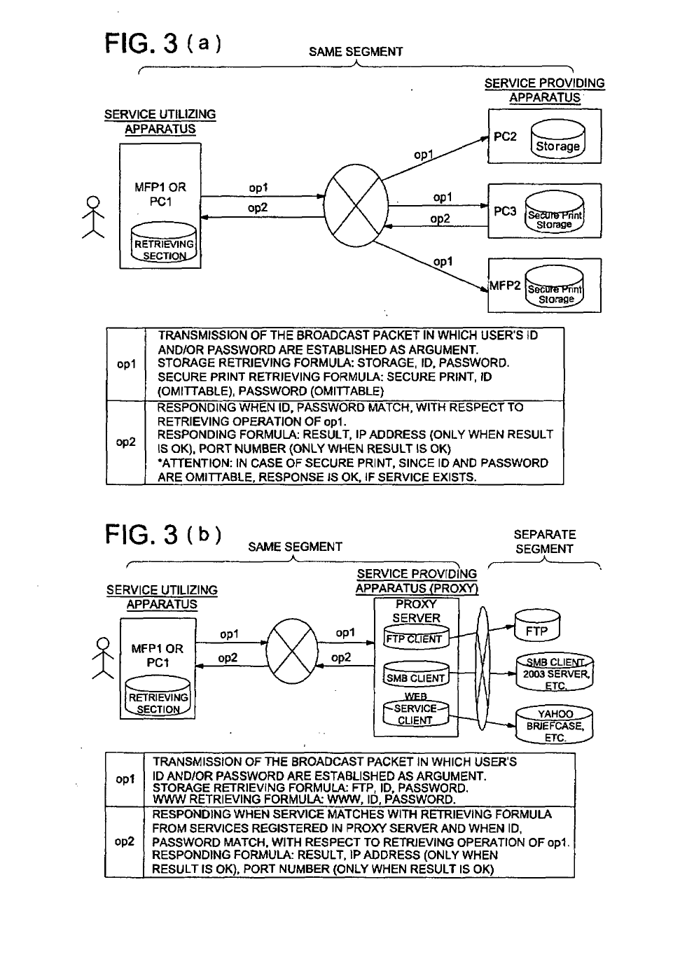

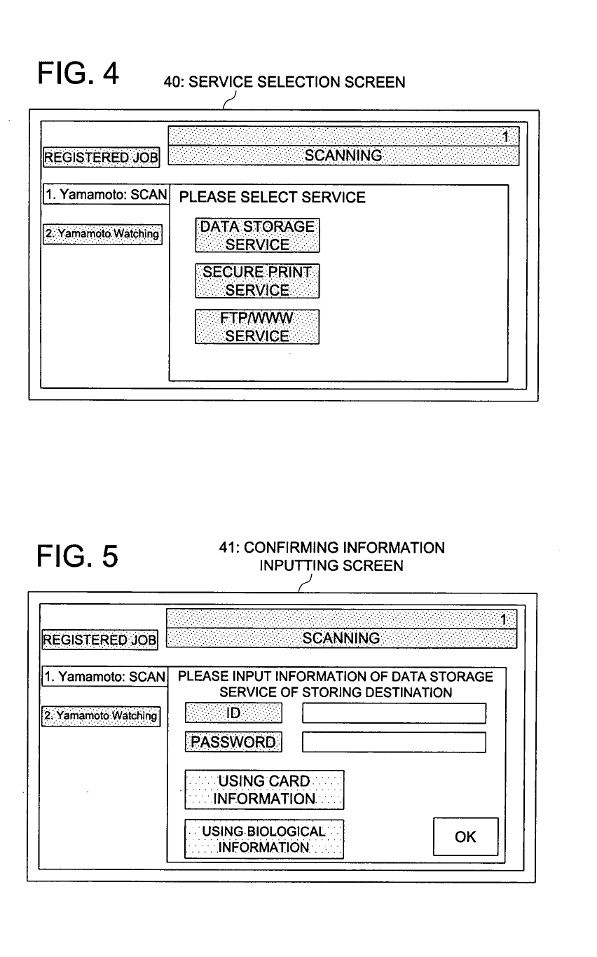

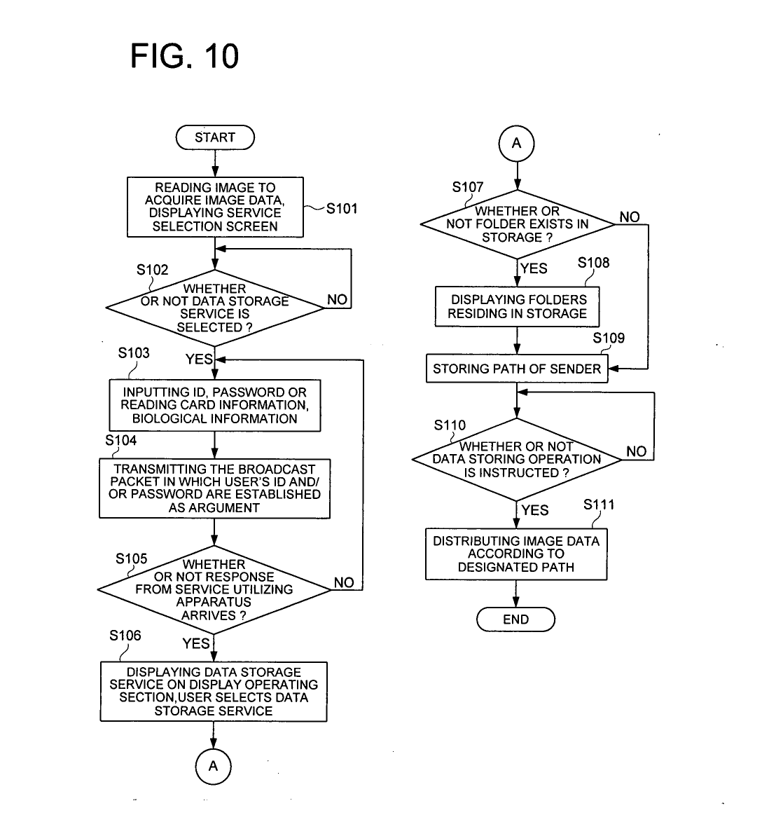

Referring to FIG. 1 through FIG. 13, a network system, a service retrieving method and an image forming apparatus, each of which is embodied in the present invention, will be detailed in the following. FIG. 1 shows a schematic diagram of the configuration of the network system embodied in the present invention, while FIG. 2(a) and FIG. 2(b) show the configuration of the image forming apparatus. Further, FIG. 3(a) and FIG. 3(b) show schematic diagrams indicating the information transmitting flow in the network system embodied in the present invention, while FIG. 4 through FIG. 9 show screen configuration examples to be displayed on the display section of the image forming apparatus. Still further, FIG. 10 through FIG. 13 show flowcharts indicating the service retrieving procedures, which utilize the network system embodied in the present invention.

As shown in FIG. 1, the network system, embodied in the present invention, is constituted by an apparatus that utilizes a service (hereinafter, referred to as a service utilizing apparatus) and another apparatus that provides the service (hereinafter, referred to as a service providing apparatus), which are coupled to each other through an communication network 30, such as a LAN (Local Area Network), a WAN (Wide Area Network), etc.

In this connection, since the apparatuses in the network system are categorized into the service utilizing apparatus and the service providing apparatus for convenience' sake, it is also applicable that each of the apparatuses serves as both the service utilizing apparatus and the service providing apparatus. Further, although each of the service utilizing apparatus and the service providing apparatus can be constituted by, for instance, an image forming apparatus 10, a terminal device 20 such as a personal computer, PDA (Personal Digital Assistants), a cellular phone, etc., the scope of the present invention is not limited to the above, and further, a number of apparatuses constituting the service utilizing apparatus or the service providing apparatus is not specifically limited, as far as the apparatus is capable of utilizing or providing the service. Still further, the term of a “service” described hereinafter in this specification includes, for instance, a service for storing data (hereinafter, referred to as a data storage service), a service for producing prints after authentication (hereinafter, referred to as a secure print service), a service for utilizing a server of a separate segment or a client (hereinafter, referred to as a FTP/WWW service), etc. However, the scope of the “service” is not limited to the above, and it is also applicable that any other service for giving a certain convenience to the user who utilizes a certain function provided with an apparatus included in the network system.

Further, as shown in FIG. 2(a) and FIG. 2(b), the image forming apparatus 10 is constituted by a control section 11 and other sections for implementing various kinds of functions. The control section 11 is provided with a CPU (Central Processing Unit) 11a, a storage 11b, a HDD (hard disc drive) 11c, a communication interface section 11d, etc., while the other sections includes an ADF (Automatic Document Feeder) 12, an image reading section 13, a paper sheet feeding section 14, a service retrieving section 15, a card/biological information reading section 16, a display operating section 17, an image forming section 18, an image outputting section 19, etc., all of which are coupled to each other through a bus. Each of the elements mentioned in the above will be detailed in the following in order.

The CPU 11a conducts the controlling operations of each of the sections, the image processing operations, etc.

The storage 11b is provided with a RAM (Random Access Memory), a ROM (Read Only Memory), etc., so as to temporarily store the various kinds of data read from the image reading section 13, the service retrieving section 15, the card/biological information reading section 16 in it. Then, the data stored in the storage 11b are processed by the CPU 11a, and the processed data are transferred to the HDD 11c and/or the image forming section 18 as needed.

The programs to be executed by the CPU 11a to control each of the sections, the information in regard to the apparatus own processing function, the information in regard to the service utilizing authentication (hereinafter, referred to as confirming information), etc. are stored in the HDD 11c, and read out by CPU 11a, so as to implement and processed them on the storage 11b.

The communication interface section 11d establishes a connection with the other apparatus coupled through the communication network 30, so as to implement the bilateral transmission of the data.

The ADF 12 automatically conveys a single document paper sheet or a plurality of document paper sheets to the image reading section 13.

The image reading section 13 reads an image of the document placed on a document plate, so as to generate image data of the image.

Print paper sheets are accommodated in the paper sheet feeding section 14 including first, second and third paper sheet feeding sections. Further, each of the first, second and third paper sheet feeding sections picks up each of the print paper sheets one by one to feed it to the image reading section 13.

The service retrieving section 15 is a module of the program stored in the ROM. When the image forming apparatus 10 serves as the service utilizing apparatus, the service retrieving section 15 creates the delivery information including the confirming information (hereinafter in the present embodiment, referred to as a packet), or when the image forming apparatus 10 serves as the service providing apparatus, the service retrieving section 15 extracts the confirming information from the broadcast packet, so as to determine whether or not the acquired confirming information agrees to the information stored in advance in the HDD 11c (or the storage 11b).

The card/biological information reading section 16 reads the card information from the IC chip embedded into the card possessed by the user, and/or reads the biological information of the user, such as a finger print, a vein pattern on the user's hand. For instance, when reading the card information, a reader of the RFID (Radio Frequency Identification) or a magnetic card reader can be employed, while, when reading the biological information, a visible light camera, a near infrared camera, etc. can be employed as the card/biological information reading section 16. However, when the ID or the password is employed as the confirming information, the card/biological information reading section 16 can be excluded from the apparatus.

The display operating section 17 displays the selection of the service and the retrieving results. In the present embodiment, the display operating section 17 is configured by mounting a touch panel on the display screen, so that it also serving as the operation section. However, the scope of operating section is not limited to the touch panel, but it is also applicable that buttons, etc. disposed at arbitral positions of the image forming apparatus 10 serve as the operating section.

The image forming section 18 includes the structural elements, for instance, a photoreceptor drum, a transferring belt, a fixing device, various kinds of conveyance belts, etc., which are necessary for the image forming operation employing the image forming process, such as the electro-photographic method, the electrostatic recording method, etc. Based on the image data read by the image reading section 13, or based on a print job received through the communication interface section 11d, the image forming section 18 forms the image on the print paper sheet, and sends it to the image outputting section 19.

The image outputting section 19 applies postprocessing, requested by the user, to the paper sheet conveyed from the image forming section 18, and outputs the finished paper sheet.

Incidentally, although the image forming apparatus 10 indicated in FIG. 2(a) and FIG. 2(b) is available as both the service utilizing apparatus and the service providing apparatus, it is also applicable that the image forming apparatus 10 is available only as any one of the service utilizing apparatus and the service providing apparatus. Further, although the configuration of the image forming apparatus 10 is indicated in FIG. 2(a) and FIG. 2(b), the terminal device 20 can be constituted by the control section 11, the service retrieving section 15, the card/biological information reading section 16, the display operating section 17, etc.

In the following, the service retrieving procedure employing the network system, including the image forming apparatus 10 having the abovementioned configuration, will be detailed for every service.

### <Data Storage Service>

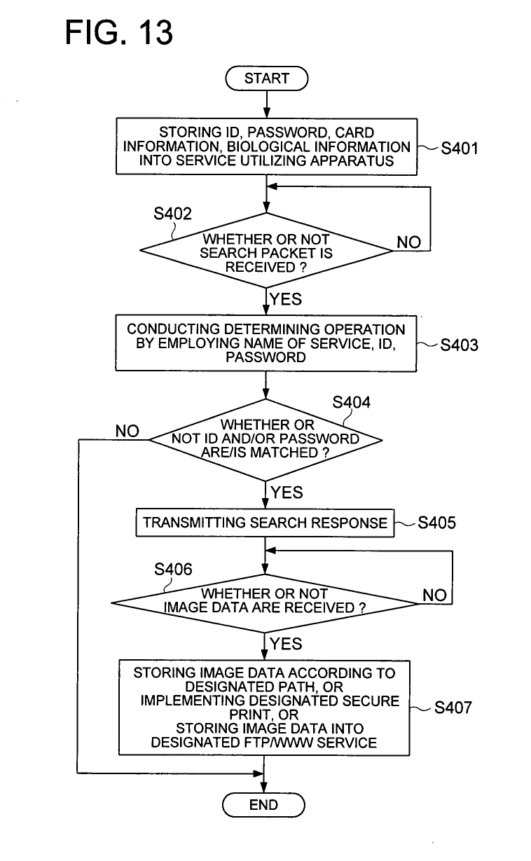

Initially, referring to the flowcharts shown in FIG. 10 and FIG. 13, the procedure for retrieving the data storage service will be detailed in the following. In this connection, in the descriptions of the above flowcharts, the image forming apparatus 10 is employed as the service utilizing apparatus, while the image forming apparatus 10 or the terminal device 20 is employed as the service providing apparatus.

The operations of the service utilizing apparatus are conducted according to the flowchart shown in FIG. 10. The CPU 11a incorporated in the image forming apparatus 10, serving as the service utilizing apparatus, executes the program stored in the ROM so as to implement the operations of this flowchart. At first, when the user puts the document paper sheet onto the ADF 12 or the document plate (platen cover) of the image reading section 13 and pushes down the copy start button in Step S101, the image reading section 13 reads the image data by scanning the image on the document paper sheet, while the CPU 11a controls the image reading section 13 and the storage 11b so as to store the image data acquired by the image reading section 13 into the storage 11b. Successively, the CPU 11a controls the display operating section 17 so as to display a service selection screen 40 shown in FIG. 4, in which a list of the services being selectable by the user is included, so that the user can select a desired service from the list.

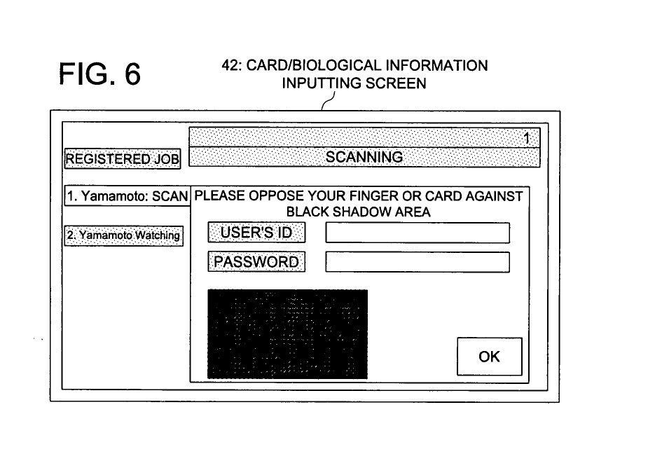

Still successively, if the user selects the “data storage service” in Step S1102, the CPU 11a controls the display operating section 17 so as to display a confirming information inputting screen 41 shown in FIG. 5. Then, the user operates the touch panel to input the confirming information to be utilized for retrieving the service (herein, the data storage service) in Step S103. Arbitral information can be employed as the confirming information, as far as the information is usable for retrieving the service. Accordingly, for instance, any one of the character information voluntarily established by the user, such as the ID and/or the password, etc., the card information stored in the IC chip embedded in the card, and the biological information of the user, such as the finger print, the vein pattern, etc., can be employed as the confirming information. When employing the ID and/or the password, the ID and/or the password are/is inputted from the confirming information inputting screen 41 shown in FIG. 5. Further, when employing the card information or the biological information of the user, the user selects either the “USAGE OF CARD INFORMATION” or the “USAGE OF BIOLOGICAL INFORMATION” on the confirming information inputting screen 41 shown in FIG. 5. Then, the CPU 11a controls the display operating section 17 so as to display a card/biological information inputting screen 42 shown in FIG. 6. Successively, when the user opposes the card, the finger or the palm of his hand against the predetermined area (indicated by the black shadow area shown in FIG. 6) in the card/biological information inputting screen 42, the card/biological information reading section 16 reads the card information stored in the IC chip embedded in the card, the finger print information, or the vein pattern on the palm of the user's hand. In this connection, the scope of the concrete structure of the card information or the biological information is not limited to a specific range, and it is also applicable that a part of the information stored in the IC chip embedded in the card is employed as the card information. Further, it is also applicable that the image information of the fingerprint or the vein pattern are employed as the biological information, or the number or coordinates of characterized points, processed according to the predetermined procedure, is/are employed as the biological information.

Still successively, in Step S104, the service retrieving section 15, serving as the program module, creates a packet, in which the information specifying the service (herein, the data storage service) selected by the user (for instance, name of the service), and the confirming information inputted by the user, such as the user's ID and/or the password, the card information, the biological information, etc., are established as the argument, while the CPU 11a controls the communication interface section 11d to broadcast the packet created in the above over the network (refer to column op1 shown in FIG. 3(a)). Concretely speaking, the packet, to which a special address indicating the whole network is attached, is transmitted to all of the apparatuses residing on the whole network system through the network. Incidentally, although the name of the service and the confirming information are included in the packet in the abovementioned example, it is also applicable that the name of the service can be omitted when the user establishes the confirming information for every service. Further, although the packet could be transmitted as it is, it is preferable that the packet is encrypted before transmitting it since the packet includes information to be concealed.

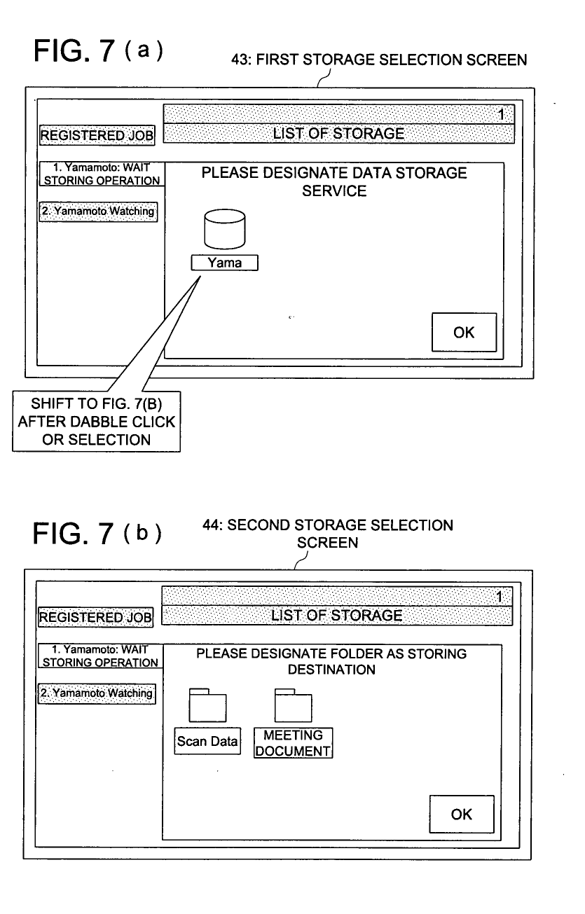

Still successively, in Step S105, the image forming apparatus 10 waits a response sent from the other image forming apparatus 10 or the terminal device 20. When none of the apparatuses send the response to the image forming apparatus 10, the process returns to Step S103, while, when any one of the apparatuses sends the response to the image forming apparatus 10, the CPU 11a controls the display operating section 17 so as to display a first storage selection screen 43 shown in FIG. 7(a) in Step S106, in which the services (herein, the data storage service) to be provided by the apparatus responding to the screen concerned are indicated, so that the user can select the data storage service currently desired from the services indicated on the screen. Further, when the folders exist in the data storage service (Step S107; Yes), the CPU 11a controls the display operating section 17 so as to display a second storage selection screen 44 shown in FIG. 7(b) in Step S108, so that the user can select the folder currently desired from the folders indicated on the screen.

Further, in Step S109, the CPU 11a temporarily stores the path of the folder designated by the user into the storage 11b, and then, if the user instructs the storing operation of the data in Step S110, the CPU 11a transmits the image data temporarily stored in the storage 11b according to the path mentioned in the above (Step S111).

On the other hand, the operations of the service providing apparatus are conducted according to the flowchart shown in FIG. 13. The CPU 11a incorporated in the image forming apparatus 10 or the terminal device 20, serving as the service providing apparatus, executes the program stored in the ROM so as to implement the operations of this flowchart. At first, in Step S401, each user operates the desired image forming apparatus 10 or the desired terminal device 20, each serving as the service providing apparatus, so as to input the confirming information in regard to the usage authentication of its own service provided by itself, while the CPU 11a stores the confirming information inputted by the user into the HDD 11c or the storage 11b. In this connection, the scope of the inputting method of the confirming information is not limited, and, for instance, the confirming information can be inputted according to the same method as that in Step S103 shown in FIG. 10.

Successively, in Step S402, when the packet, in which the name of the service and the confirming information are established as the argument, and which is transmitted by the service utilizing apparatus in Step S104 shown in FIG. 10, is received, after decoding the received broadcast packet as needed, the service retrieving section 15 extracts the name of the service and the confirming information from the packet. Then, in Step S403, the service retrieving section 15 determines whether or not the data storage service specified by the name of the service can be provided by its own apparatus, and, when determining that the data storage service can be provided, further determines whether or not the confirming information is stored in the HDD 11c or storage 11b in advance.

Further, when determining that the data storage service can be provided and the confirming information is stored in the HDD 11c or storage 11b in advance (Step S404; Yes), the CPU 11a notifies the service utilizing apparatus, serving as the sender of the broadcast packet, of the determined result (Result) and the information for specifying the own apparatus (such as the IP address, the port number, etc.) in Step S405 (refer to column op2 shown in FIG. 3(a)). In this connection, when determining that the data storage service cannot be provided or the confirming information is not stored in the HDD 11c or storage 11b in advance (Step S404; No), it is applicable that no response or only the determined result (Result) will be sent to the service utilizing apparatus.

Successively, in Step S406, when the image data transmitted from the service utilizing apparatus in Step S110 shown in FIG. 10 are received, the CPU 11a stores the received image data into the HDD 11c according to the designated path.

As mentioned in the foregoing, according to the above procedure, since it is unnecessary for the user to retrieve the apparatus capable of providing the data storage service by himself, it becomes possible to easily retrieve the data storage service desired by the user. Further, since the packet is broadcasted over the network in the abovementioned configuration, it becomes also unnecessary to disclose the structure of the whole network system, resulting in increase of the security of the network system.

### <Secure Print Service>

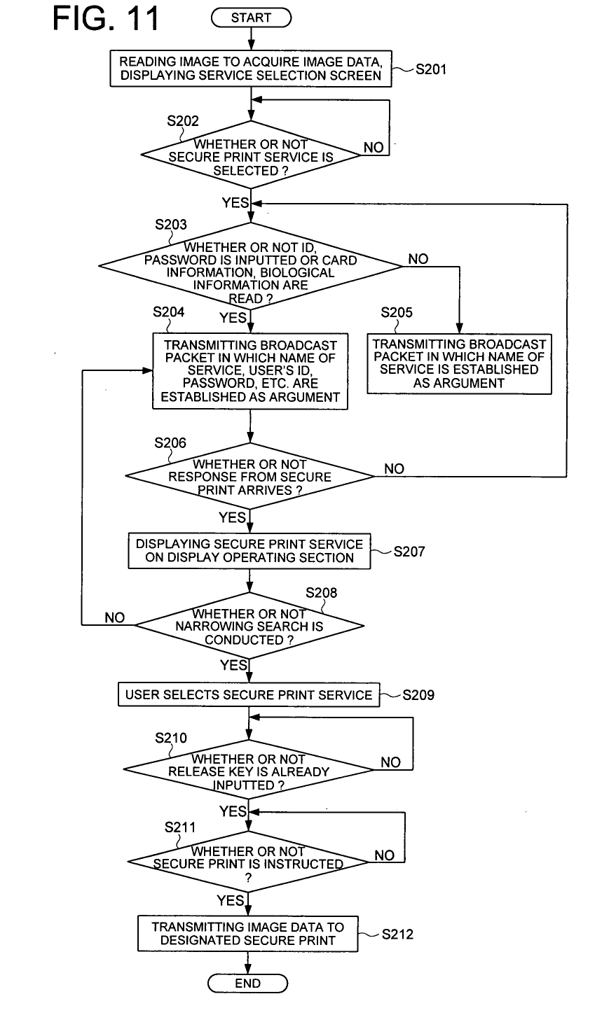

Next, referring to the flowcharts shown in FIG. 11 and FIG. 13, the procedure for retrieving the secure print service will be detailed in the following. In this connection, in the descriptions of the above flowcharts, the image forming apparatus 10 is employed as both the service utilizing apparatus and the service providing apparatus.

The operations of the service utilizing apparatus are conducted according to the flowchart shown in FIG. 11. As well as the aforementioned example in regard to the data storage service, the CPU 11a incorporated in the image forming apparatus 10, serving as the service utilizing apparatus, executes the program stored in the ROM so as to implement the operations of this flowchart. At first, the image reading section 13 of the image forming apparatus 10 reads the image data by scanning the image on the document paper sheet in Step S201, while the CPU 11a controls the image reading section 13 and the storage 11b so as to store the image data acquired by the image reading section 13 into the storage 11b. Successively, the CPU 11a controls the display operating section 17 so as to display a service selection screen 40 shown in FIG. 4, so that the user can select a desired service from the screen.

Successively, if the user selects the “secure print service” in Step S202, the CPU 11a controls the display operating section 17 so as to display a confirming information inputting screen 41 shown in FIG. 5.

Still successively, when the user inputs the confirming information, such as the user's ID and/or the password, the card information, the biological information, etc., in Step S203, the service retrieving section 15 creates a packet, in which the name of the service specifying the service (herein, the secure print service) selected by the user and the confirming information inputted by the user, such as the user's ID and/or the password, the card information, the biological information, etc., are established as the argument, while the CPU 11a controls the communication interface section 11d to broadcast the packet created in the above over the network after encrypting the packet as needed (refer to column op1 shown in FIG. 3(a)).

In this connection, in the case of the secure print service, it is also possible to retrieve any one of the image forming apparatuses. 10 capable of providing the secure print service, without inputting the user's ID and/or the password. When the user's ID and/or the password are/is not inputted (Step S203; No), the service retrieving section 15 creates a packet in which the name of the service is established as the argument (Step S205), while the CPU 11a controls the communication interface section 11d to broadcast the packet created in the above over the network.

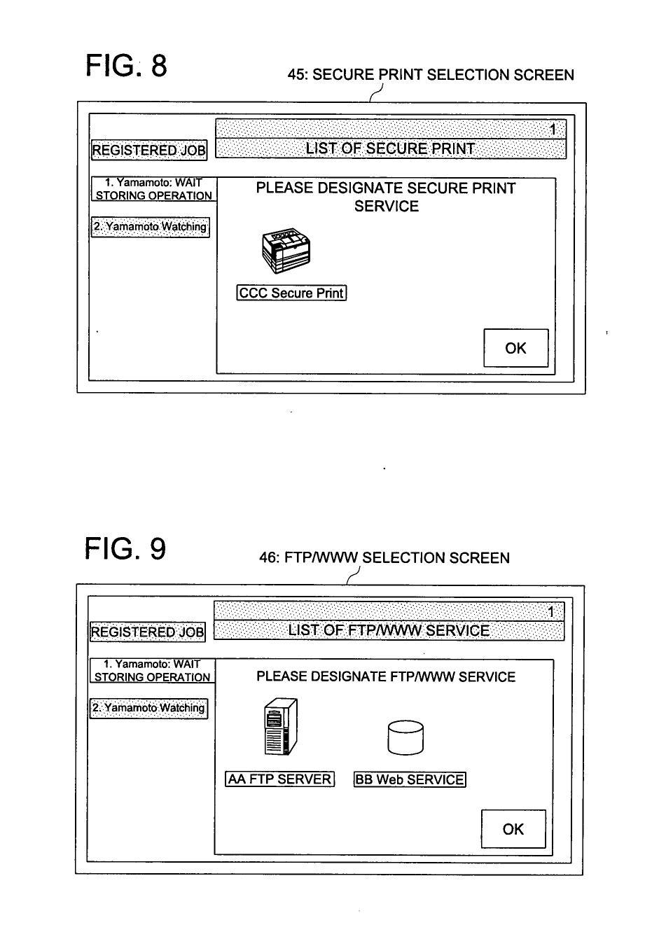

Still successively, in Step S206, the image forming apparatus 10 waits a response sent from the other image forming apparatus 10 serving as the service providing apparatus. When none of the apparatuses send the response to the image forming apparatus 10, the process returns to Step S203, while, when any one of the apparatuses sends the response to the image forming apparatus 10, the CPU 11a controls the display operating section 17 so as to display a secure print selection screen 45 shown in FIG. 8 in Step S207, in which the services (herein, the secure print service) to be provided by the apparatus responding to the screen concerned are indicated, so that the user can select the secure print service currently desired from the services indicated in the screen. In this connection, when many apparatuses capable of providing the secure print service have sent the responses to the image forming apparatus 10, it is also possible to conduct the retrieving operation again by inputting the ID and/or the password for narrowing the retrieving range in Step S208.

Still successively, if the user selects the “secure print service” on the secure print selection screen 45 in Step S209, the CPU 11a determines whether or not a release code necessary for the printing operation is already inputted in Step S210. When determining that the release code is already inputted and the user designate the secure print in Step S211, the CPU 11a transmits the image data temporarily stored in the storage 11b, in regard to the designated secure print, in Step S212.

On the other hand, the operations of the service providing apparatus are conducted according to the flowchart shown in FIG. 13. As well as the aforementioned example in regard to the data storage service, the CPU 11a incorporated in the image forming apparatus 10 or the terminal device 20, serving as the service providing apparatus, executes the program stored in the ROM so as to implement the operations of this flowchart. At first, in Step S401, each user operates the desired image forming apparatus 10 or the desired terminal device 20, each serving as the service providing apparatus, so as to input the confirming information such as the user's ID and/or the password, the card information, the biological information, etc., while the CPU 11a stores the confirming information inputted by the user into the HDD 11c or the storage 11b.

Successively, in Step S402, when the packet, in which the name of the service and the confirming information are established as the argument, and which is transmitted by the service utilizing apparatus in Step S204 shown in FIG. 11, is received, the service retrieving section 15 extracts the name of the service and the confirming information from the packet. Then, in Step S403, the service retrieving section 15 determines whether or not the secure print service specified by the name of the service can be provided by its own apparatus, and, when determining that the secure print service can be provided, further determines whether or not the confirming information is stored in the HDD 11c or storage 11b in advance. Incidentally, in the case of the secure print service, it is possible to omit the step mentioned in the above.

Further, when determining that the secure print service can be provided and the confirming information is stored in the HDD 11c or storage 11b in advance (Step S404; Yes), the CPU 11a notifies the service utilizing apparatus, serving as the sender of the broadcast packet, of the determined result (Result) and the information for specifying the own apparatus (such as the IP address, the port number, etc.) in Step S405 (refer to column op2 shown in FIG. 3(a)). In this connection, when determining that the secure print service cannot be provided or the confirming information is not stored in the HDD 11c or storage 11b in advance (Step S404; No), it is applicable that no response or only the determined result (Result) will be sent to the service utilizing apparatus.

Successively, in Step S406, when the image data transmitted from the service utilizing apparatus in Step S212 shown in FIG. 11 are received, the CPU 11a implements the secure print based on the received image data.

As mentioned in the foregoing, according to the above procedure, since it is unnecessary for the user to retrieve the apparatus capable of providing the secure print service by himself, it becomes possible to easily retrieve the secure print service desired by the user. Further, since the packet is broadcasted over the network in the abovementioned configuration, it becomes also unnecessary to disclose the structure of the whole network system, resulting in increase of the security of the network system.

### <FTP/WWW Service>

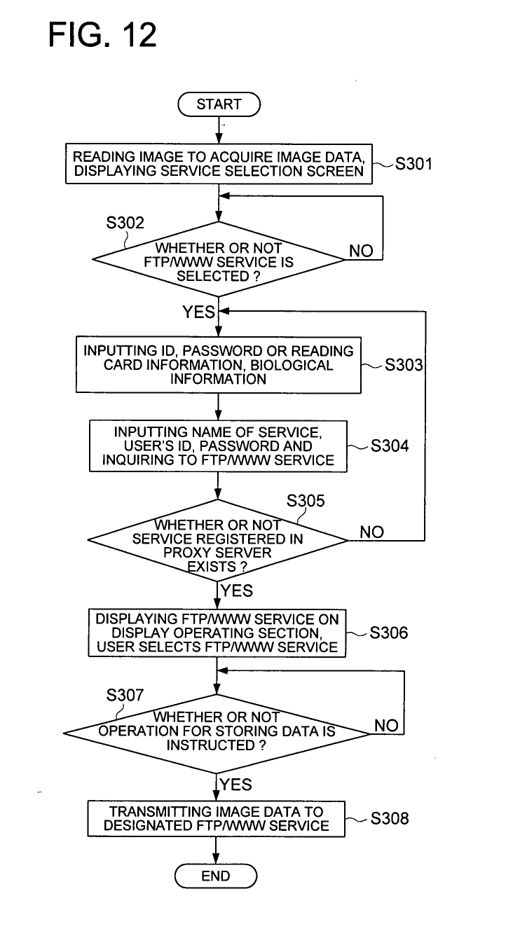

Next, referring to the flowcharts shown in FIG. 12 and FIG. 13, the procedure for retrieving the FTP/WWW (File Transfer Protocol/World Wide Web) service will be detailed in the following. In this connection, in the descriptions of the above flowcharts, the service utilizing apparatus is coupled to a proxy server, and further coupled to a server of a separate segment and/or a client through the proxy server as shown in FIG. 3(b). Further, the image forming apparatus 10 serves as the service utilizing apparatus, and the server of the separate segment and the client, each of which is capable of providing the service, are registered in advance into the proxy server.

The operations of the service utilizing apparatus are conducted according to the flowchart shown in FIG. 12. As well as the aforementioned examples in regard to the data storage service and the secure print service, the CPU 11a incorporated in the image forming apparatus 10, serving as the service utilizing apparatus, executes the program stored in the ROM so as to implement the operations of this flowchart. At first, the image reading section 13 of the image forming apparatus 10 reads the image data by scanning the image on the document paper sheet in Step S301, while the CPU 11a controls the image reading section 13 and the storage 11b so as to store the image data acquired by the image reading section 13 into the storage 11b. Successively, the CPU 11a controls the display operating section 17 so as to display a service selection screen 40 shown in FIG. 4, so that the user can select a desired service from the screen.

Successively, if the user selects the “FTP/WWW service” in Step S302, the CPU 11a controls the display operating section 17 so as to display a confirming information inputting screen 41 shown in FIG. 5.

Still successively, when the user inputs the confirming information, such as the user's ID and/or the password, the card information, the biological information, etc., in Step S303, the service retrieving section 15 creates a packet, in which the name of the service specifying the service (herein, the FTP/WWW service) selected by the user and the confirming information inputted by the user, such as the user's ID and/or the password, the card information, the biological information, etc., are established as the argument in Step S304, while the CPU 11a controls the communication interface section 11d to broadcast the packet created in the above over the network (refer to column op1 shown in FIG. 3(b)). In this occasion, according to the flowchart shown in FIG. 12, the broadcast packet is also transmitted to proxy servers of a FTP client, a SMB (Service Message Block) client, a Web service client, etc.

Still successively, in Step S305, the CPU 11a of the image forming apparatus 10 determines whether or not the service registered in the proxy server exists. When determining that the service exists, the CPU 11a controls the display operating section 17 so as to display a FTP/WWW selection screen 46 shown in FIG. 9 in Step S306, in which the services (herein, the FTP/WWW service), responding to the screen concerned, are indicated, so that the user can select the FTP/WWW service currently desired from the services indicated in the screen.

Still successively, in Step S307, if the user instructs the data storing operation, the CPU 11a transmits the image data temporarily stored in the storage 11b, in regard to the designated FTP/WWW service.

On the other hand, the operations of the service providing apparatus are conducted according to the flowchart shown in FIG. 13. As well as the aforementioned examples in regard to the data storage service and the secure print service, the CPU 11a incorporated in the image forming apparatus 10 or the terminal device 20, serving as the service providing apparatus, executes the program stored in the ROM so as to implement the operations of this flowchart. At first, in Step S401, each user makes the proxy server store the confirming information such as the user's ID and/or the password, the card information, the biological information, etc., which are to be utilized for retrieving the service (herein, the FTP/WWW service)

Successively, in Step S402, when the proxy server receives the packet, in which the name of the service and the confirming information are established as the argument, and which is transmitted by the service utilizing apparatus in Step S304 shown in FIG. 12, the proxy server extracts the name of the service and the confirming information from the packet. Then, in Step S403, the proxy server determines whether or not the server of the separate segment or the client, capable of providing the FTP/WWW service specified by the name of the service, is registered in advance, and when determining that the server of the separate segment or the client is registered, further determines whether or not the confirming information is stored in advance.

Further, when determining that the server of the separate segment or the client is registered and the confirming information is stored in advance (Step S404; Yes), the proxy server notifies the service utilizing apparatus, serving as the sender of the broadcast packet, of the determined result (Result) and the information for specifying the server of the separate segment or the client, capable of providing the FTP/WWW service (such as the IP address, the port number, etc.), in Step S405 (refer to column op2 shown in FIG. 3(b)). In this connection, when determining that the FTP/WWW service is not registered or the confirming information is not stored in advance (Step S404; No), it is applicable that no response or only the determined result (Result) will be sent to the service utilizing apparatus.

Successively, in Step S406, when the image data transmitted from the service utilizing apparatus in Step S308 shown in FIG. 12 are received, the proxy server transmits the concerned image data to the server of the separate segment or the client, capable of providing the FTP/WWW service, so as to make it store the image data concerned (Step S407).

As mentioned in the foregoing, when utilizing the FTP/WWW service provided by the server of the separate segment or the client according to the above procedure, since the proxy server conducts the responding operations as a proxy for the user, it becomes possible to easily retrieve the FTP/WWW service desired by the user. Further, since the existence of the service utilizing apparatus is not perceptible for the server of the separate segment or the client, it becomes possible to heighten the security level of the network system.

Incidentally, the scope of the present invention is not limited to the embodiments mentioned in the foregoing. For instance, although the configuration in which the programs including the service retrieving section 15 are stored in the ROM has been cited as the example of the present invention, it is also applicable that such the programs are also stored in the HDD other than the ROM. Further, it is also applicable that the programs are introduced into the HDD or the ROM from the detachable storage device, such as a CD-ROM, a floppy (Registered Trade Mark) disc, etc. Further, in this case, it is applicable that the programs are stored in the detachable storage device in a state of compressed data and/or in such a state that the programs can be functioned only when the programs are introduced into the HDD or the ROM by employing specific installation programs. Still further, although the network system including the image forming apparatus has been exemplified as the embodiment of the present invention in the foregoing, the present invention can be generally applied to every kind of network system, which includes an apparatus utilizing an arbitral service and another apparatus providing the service, as well.

The present invention is usable (applicable) for an arbitral network system that includes the service utilizing apparatus and the service providing apparatus, a service retrieving method to be employed in the above network system, and the service utilizing apparatus and the service providing apparatus, both of which constitute the above network system.

According to the network system, the service retrieving method and the image forming apparatus, embodied in the present invention, the following effects can be attained.

One of the effects of the present invention is to easily notify the service utilizing apparatus, which wishes to utilize a specific service, or the user, who currently using the service utilizing apparatus concerned, of the service providing apparatus being providable of the specific service. This is because, instead of displaying a list covering all of the apparatuses residing on the network in an identifiable manner on the screen, so that the user can determine and select a certain apparatus, being capable of providing the specific service, out of all of the apparatuses displayed, as in the conventional network system, the network system embodied in the present invention is so constituted that the service utilizing apparatus broadcasts the delivery information including the confirming information, so that each of the service providing apparatuses can determine whether or not the first confirming information included in the delivery information agrees to the second confirming information stored in advance in the storage section, and when the service providing apparatus determines that the first confirming information agrees to the second confirming information, the service providing apparatus transmits specific information for specifying the service providing apparatus itself to the service utilizing apparatus.

Another one of the effects of the present invention is to heighten the security level of the network system. This is because, instead of retrieving the providable service desired by the user by himself, as in the conventional network system, since the service providing apparatus, which receives the delivery information including the confirming information broadcasted by the service utilizing apparatus, determines whether or not the service providing apparatus itself is capable of providing its own service as the service desired by the user, it is unnecessary to bilaterally disclose all of the apparatuses residing on the network in such a manner that all of the apparatuses are totally perceptible for the users of them relative to each other.

While the preferred embodiments of the present invention have been described using specific term, such description is for illustrative purpose only, and it is to be understood that changes and variations may be made without departing from the spirit and scope of the appended claims.

What is claimed is:

1. A network system, comprising:
a service providing apparatus that provides a service;
a service utilizing apparatus that utilizes the service provided by the service providing apparatus; and
a network through which the service providing apparatus and the service utilizing apparatus bilaterally communicate with each other;
wherein the service utilizing apparatus includes:
a first communicating section that is connected to the network; and
a first control section that creates delivery information including first confirming information, which is necessary for authenticating a usage of the service, and broadcasts the delivery information onto the network through the first communicating section; and
wherein the service providing apparatus includes:
a second communicating section that is connected to the network;
a storage section to store second confirming information in regard to a usage authentication of own service being providable by the service providing apparatus; and
a second control section that receives the delivery information through the second communicating section, and determines whether or not the first confirming information included in the delivery information agrees to the second confirming information stored in advance in the storage section; and
wherein, when the second control section determines that the first confirming information agrees to the second confirming information, the second control section transmits specific information for specifying the service providing apparatus to the service utilizing apparatus through the second communicating section.

2. The network system of claim 1,
wherein the first control section of the service utilizing apparatus makes the delivery information include information for specifying a kind of service to be utilized; and
wherein the second control section of the service providing apparatus determines whether or not the kind of service, specified by the information included in the delivery information, is providable by the service providing apparatus, and, when determining that the kind of service is providable, the second control section determines whether or not the first confirming information included in the delivery information agrees to the second confirming information stored in advance in the storage section.

3. The network system of claim 1,
wherein at least one of the service utilizing apparatus and the service providing apparatus is an image forming apparatus; and
wherein the service is either a data storage service for storing image data generated by the image forming apparatus, or a secure print service for outputting a print based on the image data, after an authenticating process is completed.

4. The network system of claim 1,
wherein the confirming information includes at least one of a user's ID and a password, both for identifying a user.

5. A network system, comprising:
a service providing apparatus that provides a service;
a service utilizing apparatus that utilizes the service provided by the service providing apparatus; and
a proxy server through which a first network including the service utilizing apparatus and a second network including the service providing apparatus are coupled to each other;
wherein the service utilizing apparatus includes:
a first communicating section that is connected to the first network; and
a first control section that creates delivery information including first confirming information in regard to a usage authentication of an inputted service, so as to broadcast the delivery information onto the first network through the first communicating section; and
wherein the proxy server includes:
a second communicating section that is connected to both the first network and the second network;
a storage section to store second confirming information in regard to a usage authentication of the service being providable by the service providing apparatus;
a second control section that receives the delivery information through the second communicating section, to determine whether or not the first confirming information included in the delivery information agrees to the second confirming information stored in advance in the storage section; and
wherein, when the second control section determines that the first confirming information agrees to the second confirming information, the second control section transmits specific information for specifying the service providing apparatus, registered in advance in the service utilizing apparatus, to the service utilizing apparatus through the second communicating section.

6. The network system of claim 5,
wherein the first control section of the service utilizing apparatus makes the delivery information include information for specifying a kind of service to be utilized; and
wherein the proxy server determines whether or not the service providing apparatus, which is capable of providing the service specified by the information included in the delivery information, is registered in advance, and, when determining that the service providing apparatus is registered in advance, the proxy server further determines whether or not the first confirming information included in the delivery information agrees to the second confirming information stored in advance in the storage section.

7. The network system of claim 5,
wherein at least one of the service utilizing apparatus and the service providing apparatus is an image forming apparatus; and
wherein the service is either a data storage service for storing image data generated by the image forming apparatus, or a secure print service for outputting a print based on the image data, after an authenticating process is completed.

8. The network system of claim 5,
wherein the confirming information includes at least one of a user's ID and a password, both for identifying a user.

9. A service retrieving method to be employed in a network system, which includes a service providing apparatus that provides a service, a service utilizing apparatus that utilizes the service provided by the service providing apparatus, and a network through which the service providing apparatus and the service utilizing apparatus bilaterally communicate with each other, the service retrieving method comprising:
creating delivery information including first confirming information, which is necessary for authenticating a usage of the service, in the service utilizing apparatus;
broadcasting the delivery information from the service utilizing apparatus on the network;
storing second confirming information in regard to a usage authentication of own service being providable by the service providing apparatus into a storage section of the service providing apparatus; and
determining whether or not the first confirming information included in the delivery information, received from the service utilizing apparatus, agrees to the second confirming information stored in advance in the storage section;
wherein, when the service providing apparatus determines that the first confirming information agrees to the second confirming information, the service providing apparatus transmits specific information for specifying the service providing apparatus to the service utilizing apparatus through the network.

10. The service retrieving method of claim 9, further comprising:
including information for specifying a kind of service, to be utilized by the service utilizing apparatus, into the delivery information, in the creating step; and
wherein the service providing apparatus determines whether or not the kind of service, specified by the information included in the delivery information, is providable by the service providing apparatus, and, when determining that the kind of service is providable, the service providing apparatus determines whether or not the first confirming information included in the delivery information agrees to the second confirming information stored in advance in the storage section.

11. The service retrieving method of claim 9,
wherein at least one of the service utilizing apparatus and the service providing apparatus is an image forming apparatus; and
wherein the service is either a data storage service for storing image data generated by the image forming apparatus, or a secure print service for outputting a print based on the image data, after an authenticating process is completed.

12. The service retrieving method of claim 9,
wherein the confirming information includes at least one of a user's ID and a password, both for identifying a user.

13. A service retrieving method to be employed in a network system, which includes a service providing apparatus that provides a service, a service utilizing apparatus that utilizes the service provided by the service providing apparatus, and a proxy server through which a first network including the service utilizing apparatus and a second network including the service providing apparatus are coupled to each other, the service retrieving method comprising:
creating delivery information including first confirming information, which is necessary for authenticating a usage of the service, in the service utilizing apparatus;
broadcasting the delivery information from the service utilizing apparatus on the first network;
storing second confirming information in regard to a usage authentication of own service being providable by the service providing apparatus into a storage section of the proxy server; and
determining whether or not the first confirming information included in the delivery information, received from the service utilizing apparatus, agrees to the second confirming information stored in advance in the storage section;
wherein, when the proxy server determines that the first confirming information agrees to the second confirming information, the proxy server transmits specific information for specifying the service providing apparatus, registered in advance in the service utilizing apparatus, to the service utilizing apparatus through the network.

14. The service retrieving method of claim 13, further comprising:
including information for specifying a kind of service, to be utilized by the service utilizing apparatus, into the delivery information, in the creating step; and
wherein the proxy server determines whether or not the service providing apparatus, which is capable of providing the service specified by the information included in the delivery information, is registered in advance, and, when determining that the service providing apparatus is registered in advance, the proxy server further determines whether or not the first confirming information included in the delivery information agrees to the second confirming information stored in advance in the storage section.

15. The service retrieving method of claim 13,
wherein at least one of the service utilizing apparatus and the service providing apparatus is an image forming apparatus; and
wherein the service is either a data storage service for storing image data generated by the image forming apparatus, or a secure print service for outputting a print based on the image data, after an authenticating process is completed.

16. The service retrieving method of claim 13,
wherein the confirming information includes at least one of a user's ID and a password, both for identifying a user.

17. An image forming apparatus, comprising:
a communicating section that is coupled to a service providing apparatus included in a network system through a network thereof; and
a control section that creates delivery information including first confirming information, which is necessary for authenticating a usage of a service, so as to broadcast the delivery information onto the network through the communicating section.

18. The image forming apparatus of claim 17
wherein the first control section of the service utilizing apparatus makes the delivery information include information for specifying a kind of service to be utilized, so as to broadcast the delivery information including the information for specifying a kind of service onto the network.

19. The image forming apparatus of claim 17
wherein the service is either a data storage service for storing image data generated by the image forming apparatus, or a secure print service for outputting a print based on the image data, after an authenticating process is completed.

20. The image forming apparatus of claim 17,
wherein the confirming information includes at least one of a user's ID and a password, both for identifying a user.

21. An image forming apparatus, comprising:
a communicating section that is coupled to a service utilizing apparatus included in a network system through a network thereof, wherein the service utilizing apparatus includes a first control section that creates delivery information including first confirming information, which is necessary for authenticating a usage of the service, so as to broadcast the delivery information onto the network;
a storage section to store second confirming information in regard to a usage authentication of own service being providable by the image forming apparatus; and
a second control section that receives the delivery information through the communicating section, to determine whether or not the first confirming information included in the delivery information agrees to the second confirming information stored in advance in the storage section; and
wherein, when the second control section determines that the first confirming information agrees to the second confirming information, the second control section transmits specific information for specifying the service providing apparatus to the service utilizing apparatus through the communicating section.

22. The image forming apparatus of claim 21
wherein the delivery information include information for specifying a kind of service to be utilized by the service utilizing apparatus; and
wherein the second control section determines whether or not the image forming apparatus is capable of providing the service, specified by the information included in the delivery information, and, when determining that the image forming apparatus is capable of providing the service, the second control section further determines whether or not the first confirming information included in the delivery information agrees to the second confirming information stored in advance in the storage section.

23. The image forming apparatus of claim 21
wherein the service is either a data storage service for storing image data generated by the image forming apparatus, or a secure print service for outputting a print based on the image data, after an authenticating process is completed.

24. The image forming apparatus of claim 21,
wherein the confirming information includes at least one of a user's ID and a password, both for identifying a user.
